(19) United States
(12) Patent Application Publication
(10) Pub. No.: US 2025/0327487 A1
(43) Pub. Date: Oct. 23, 2025

(54) STUB SHAFT TO CVJ WHEEL END

(71) Applicant: Dana Automotive Systems Group, LLC, Maumee, OH (US)

(72) Inventors: Corey KWAPICH, Ottawa Lake, MI (US); Dustin BROOKS, Maumee, OH (US); Anthony PESCARA, Oregon, OH (US)

(21) Appl. No.: 19/177,202

(22) Filed: Apr. 11, 2025

Related U.S. Application Data
(60) Provisional application No. 63/636,419, filed on Apr. 19, 2024.

(51) Int. Cl. F16D 3/223

(52) U.S. Cl. CPC F16D 3/223; F16D 2003/22326

(57) ABSTRACT

A wheel end assembly of a vehicle is disclosed, including a constant velocity joint (CVJ) with an outer race having a bore with an internal splined interface that is configured to mate with an external splined interface of a stub shaft that is fastened to a wheel hub of the wheel end assembly. The stub shaft is a removable component that is manufactured separately from the outer race of the CVJ. As a result, a size of the outer race may be reduced in comparison with CVJs having outer races with integrated shafts. In this way, the disclosed system provides for a wheel assembly that can be manufactured in parts that do not exceed size or length thresholds above which manufacturing may be complicated or undesirable.

### CROSS REFERENCE TO RELATED APPLICATIONS

The present application claims priority to U.S. Provisional Application No. 63/636,419, entitled “STUB SHAFT TO CVJ WHEEL END”, and filed on Apr. 19, 2024. The entire contents of the above-listed application are hereby incorporated by reference for all purposes.

### TECHNICAL FIELD

The present description relates to a constant velocity joint assembly for a wheel end with an input to a wheel hub.

### BACKGROUND AND SUMMARY

A vehicle may have an axle assembly that includes an input rotational element, such as an axle shaft, that couples to a wheel of the vehicle. The axle shaft may be rotationally coupled to the wheel via one or more constant velocity joints (CVJs). A CVJ of the one or more CVJs may couple the axle shaft to a second shaft that rigidly couples with a hub adapter of a wheel hub of the wheel. The second shaft may be integrated with an outer race of the CVJ as a single unit. The integrated second shaft may rigidly couple to the wheel hub of the wheel assembly via a plurality of external splines. The plurality of external splines may mate with the hub adaptor of the wheel hub.

However, such a CVJ design may present certain challenges when manufacturing the outer race and the integrated second shaft as a single unit. In particular, a length of the second shaft may be longer than a threshold length imposed by manufacturers. The inventors herein have recognized these and other issues with such systems, and have developed approaches to at least partially solve them. In one example, a wheel end assembly comprises a wheel hub assembly; a stub shaft having a first end including an external splined interface, and a second end including a flange configured to be fastened to the wheel hub assembly; and a constant velocity joint (CVJ), where the CVJ includes an outer race comprising a bore with an internal splined interface configured to mate with the external splined interface of the stub shaft.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an example schematic of a vehicle which may include one or more of the constant velocity joints (CVJs) and wheel assemblies of the present disclosure.

FIG. 2 shows an exploded view of an assembly including a CVJ and a hub assembly of the present disclosure.

FIG. 3 shows a sectional view of the assembly.

### DETAILED DESCRIPTION

The following description relates to a shaft that may rigidly couple a feature of the joint assembly to a hub assembly. The shaft is a stub shaft. The shaft is a separate component from the joint assembly and a constant velocity joint (CVJ) of the assembly. More specifically, the shaft is a separate component from an outer race of the CVJ, where the shaft is removable from coupling with an outer race. The joint assembly includes the CVJ and a spindle.

The shaft has an input side and an output side, where the input side may receive torque from a component and the output side may deliver torque to another component. The input side may couple to the joint assembly. The output side may couple to the hub assembly. The shaft includes a fastening section with splines on the input side of the shaft. The input side fastening feature may couple to the outer race of the CVJ. The shaft includes another fastening section on the output side, where the output side fastening feature lacks splines. The output side fastening feature may be a flange. The hub assembly lacks a hub adapter.

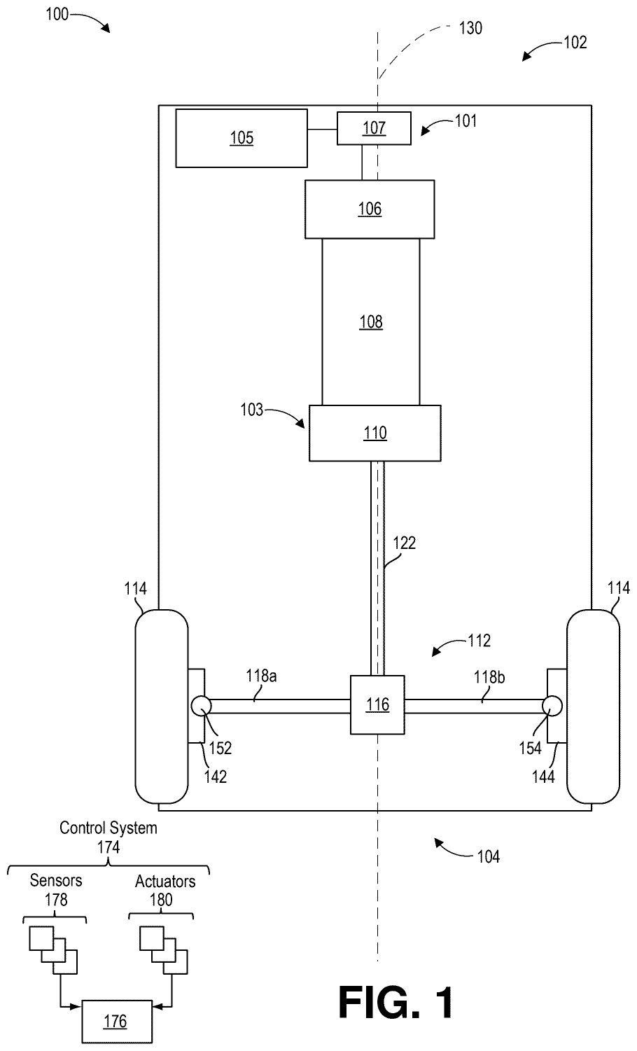

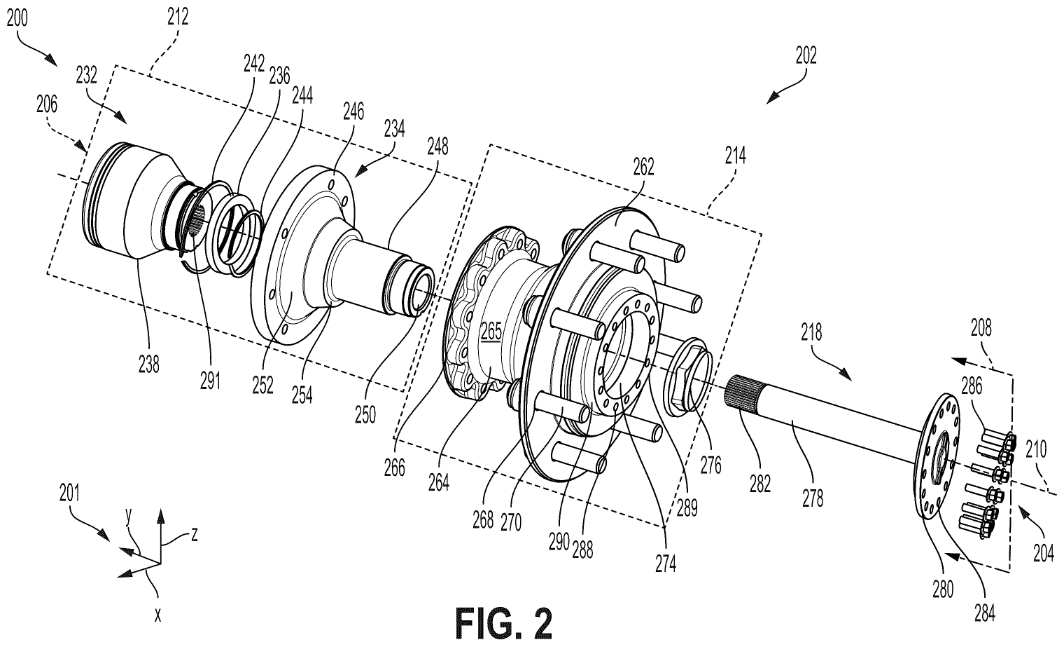

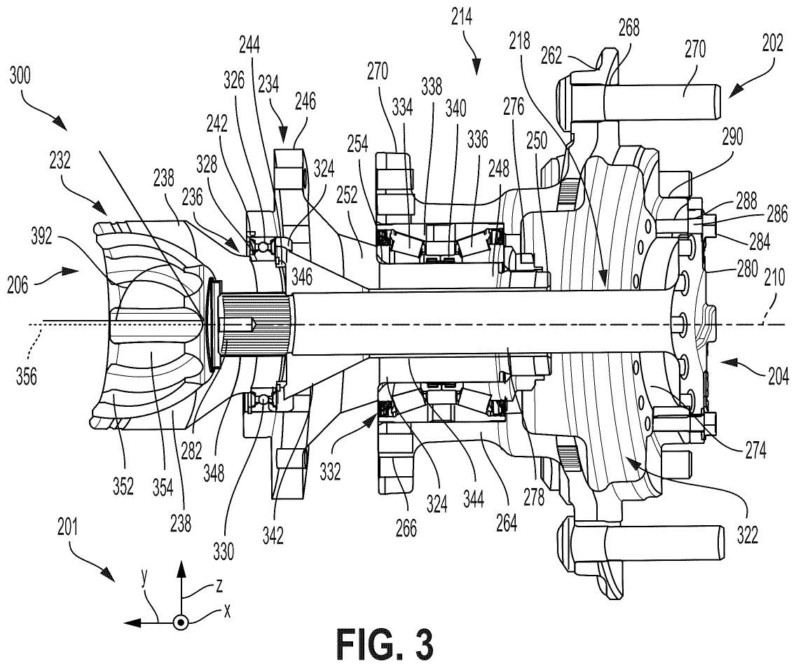

FIG. 1 shows an example schematic of a vehicle which may include one or more of the constant velocity joints (CVJs) and a wheel end assemblies of the present disclosure. FIG. 2 shows an exploded view of an assembly including a CVJ and a wheel hub of the present disclosure. FIG. 3 shows a sectional view of the assembly. The assembly of FIGS. 2-3 is a wheel end assembly, where the hub assembly may rigidly couple to a wheel.

It is also to be understood that the specific assemblies and systems illustrated in the attached drawings, and described in the following specification are exemplary embodiments of the inventive concepts defined herein. For purposes of discussion, the drawings are described collectively. Thus, like elements may be commonly referred to herein with like reference numerals and may not be re-introduced.

FIG. 1 shows a schematic of an example configuration with relative positioning of the various components. FIGS. 2-3 show example configurations with approximate position. FIGS. 2-3 are shown approximately to scale; though other relative dimensions may be used. As used herein, the terms “approximately” is construed to mean plus or minus five percent of the range unless otherwise specified.

Further, FIGS. 1-3 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. Moreover, the components may be described as they relate to reference axes included in the drawings.

Features described as axial may be approximately parallel with an axis referenced unless otherwise specified. Features described as counter-axial may be approximately perpendicular to the axis referenced unless otherwise specified. Features described as radial may circumferentially surround or extend outward from an axis, such as the axis referenced, or a component or feature described prior as being radial to a referenced axis, unless otherwise specified.

Features described as longitudinal may be approximately parallel with an axis that is longitudinal. A lateral axis may be normal to a longitudinal axis and a vertical axis. Features described as lateral may be approximately parallel with the lateral axis. A vertical axis may be normal to a lateral axis and a longitudinal axis. Features described as vertical may be approximately parallel with a vertical axis with respect to gravity.

Features described as drivingly coupled are coupled such as to drive one another. Said in another way, a first component drivingly coupled to a second component may drive the second component and vice versa.

Turning now to FIG. 1, a vehicle 100 is shown comprising a powertrain 101 and a drivetrain 103. The vehicle 100 may have a front end 102 and a rear end 104. Objects, components, and features of the vehicle 100 referred to as being located near the front may be closest to the front end 102 compared to the rear end 104. Objects, components, and features of the vehicle 100 referred to as being located near the rear may be closest to the rear end 104 compared to the front end 102. The vehicle 100 may have a longitudinal axis 130. The powertrain 101 and drivetrain 103 may have a length parallel with the longitudinal axis 130.

The powertrain 101 comprises a prime mover 106 and a transmission 108. For an example, the prime mover 106 may be an internal combustion engine (ICE). For another example, the prime mover 106 may be an electric machine. The prime mover 106 is operated to provide rotary power to the transmission 108. The transmission 108 receives the rotary power produced by the prime mover 106 as an input and outputs rotary power to the drivetrain 103 in accordance with a selected gear or setting.

The vehicle 100 may be a commercial vehicle, light, medium, or heavy duty vehicle, a passenger vehicle, an off-highway vehicle, a commercial vehicle, agricultural vehicle, and/or sport utility vehicle. For an example embodiment, the vehicle 100 may be a wheeled vehicle, such as an automobile. However, additionally or alternatively, the vehicle 100 may be plane, a boat, or other vehicle system. Additionally or alternatively, the vehicle 100 and/or one or more of its components, such as components of the powertrain 101 and/or the drivetrain 103, may be used in industrial, locomotive, military, agricultural, and/or aerospace applications. In an example, the vehicle 100 is an all-electric vehicle or a vehicle with all-electric modes of operation, such as a plug-in hybrid vehicle. As such, the prime mover 106 may be an electric machine, such as an electric motor/generator. For an example, the vehicle 100 may be a hybrid vehicle, wherein there are multiple torque inputs to the transmission 108. As such there may be at least another mover with an input to the transmission 108 besides prime mover 106. If the prime mover is an ICE or another non-electric machine mover, the other mover may be an electric machine, such as an electric motor or an electric motor/generator.

The prime mover 106 may be powered via energy from an energy storage device 105. For example, the energy storage device 105 is a battery, such as a traction battery, configured to store electrical energy. An inverter 107 may be arranged between the energy storage device 105 and the prime mover 106 and configured to adjust direct current (DC) to alternating current (AC). The inverter 107 may include a variety of components and circuitry with thermal demands that effect an efficiency of the inverter.

The drivetrain 103 may include an axle assembly 112. The axle assembly 112 may be configured to drive a set of wheels 114. In one example, the axle assembly 112 is arranged near the rear of the vehicle 100 and thereby comprises a rear axle. For another example, the axle assembly 112 may be arranged near the front of the vehicle 100 and thereby comprise a front axle. For another example, there may be an additional axle assembly arranged near the front of the vehicle 100 separate from the axle assembly 112. The additional axle assembly may be coupled to the transmission such as to be driven by the transmission 108 or another transmission. The vehicle 100 may include additional wheels that are not coupled to the drivetrain 103.

The vehicle 100 may have a driveshaft 122. The transmission 108 may be coupled the axle assembly 112 via the driveshaft 122. Said in another way, the transmission 108 may couple to the driveshaft 122, and the driveshaft 122 may couple to the axle assembly 112. In some configurations, such as shown in FIG. 1, the drivetrain 103 includes a transfer case 110 configured to receive rotary power output by the transmission 108. The driveshaft 122 may drivingly couple to the transfer case 110 and may be drivingly coupled to the transmission 108 via the transfer case 110.

The axle assembly 112 may include a differential 116 and a first set of axle shafts. The differential 116 may couple with the first set of axle shafts such as to transfer torque to and drive the first set of axle shafts. The first set of axle shafts may include a first shaft 118a and a second shaft 118b. The first shaft 118a and the second shaft 118b may be axle half shafts. The differential 116 may distribute unequal torque to wheels 114 coupled to opposite ends of the axle assembly 112. For example, the differential 116 may distribute a first torque to the first shaft 118a, and a second torque to the second shaft 118b.

The axle shafts 118a, 118b may couple to the set of wheels 114 via a set of wheel end assemblies and a plurality of joints. For example, the first set of wheel end assemblies may include a first wheel end assembly 142 and a second wheel end assembly 144. The first wheel end assembly 142 may couple to a first wheel of the set of wheels 114. Likewise, the second wheel end assembly 144 may couple to a second wheel of the set of wheels 114. The first wheel coupled to the first wheel end assembly 142 may be opposite the axle assembly 112 from the second wheel coupled to the second wheel end assembly 144. The first wheel end assembly 142 has a first joint 152, and the second wheel end assembly 144 has a second joint 154. The first shaft 118a may couple to the first wheel end assembly 142 via the first joint 152. The second shaft 118b may couple to the second wheel end assembly 144 via the second joint 154. Torque outputted by the differential 116 to the first shaft 118a may drive the first wheel end assembly 142 and the first wheel via first joint 152. Torque outputted by the differential 116 to the second shaft 118b may drive the second wheel end assembly 144 and the second wheel via second joint 154.

The vehicle 100 and drivetrain 103 may include a plurality of CVJs. A CVJ may couple at least a first rotational element and a second rotational element, such as a shaft and a wheel assembly, such that the first rotational element and the second rotational may rotate or pivot freely, and the first rotational element may drive the second rotational element, and vice versa, at an angle between the first rotational element and the second rotational element. The CVJ may compensate for the angle between the first rotational element and the second rotational element, which may be within a range of angles. The angle between the first rotational element and the second rotational element may change during operation of the vehicle 100, where a position of the first axle shaft 118a or the second axle shaft 118b may change. For example, the first joint 152 and the second joint 154 may be CVJs. Additionally, other CVJs may couple to other shafts and rotational elements of vehicle 100.

Adjustment of the drivetrain 103 between the various modes of operation as well as control of operations within each mode may be executed based on a vehicle control system 174, including a controller 176. Controller 176 may be a microcomputer, including elements such as a microprocessor unit, input/output ports, an electronic storage medium for executable programs and calibration values, e.g., a read-only memory chip, random access memory, keep alive memory, and a data bus. The storage medium can be programmed with computer readable data representing instructions executable by a processor for performing the methods described below as well as other variants that are anticipated but not specifically listed. In one example, controller 176 may be a powertrain control module (PCM).

Controller 176 may receive various signals from sensors 178 coupled to various regions of vehicle 100. For example, the sensors 178 may include sensors at the prime mover 106 or another mover to measure mover speed and mover temperature, a pedal position sensor to detect a depression of an operator-actuated pedal, such as an accelerator pedal or a brake pedal, a lever position sensor to detect a shifting of a lever, such as a brake lever, speed sensors at the set of wheels 114 etc. Upon receiving the signals from the various sensors 178 of FIG. 1, controller 176 processes the received signals, and employs various actuators 180 of vehicle 100 to adjust drivetrain operations based on the received signals and instructions stored on the memory of controller 176. For example, controller 176 may receive an indication of depression of the brake pedal, signaling a desire for decreased vehicle speed. Vehicle braking may be directly proportional to accelerator pedal position, for example, degree of depression. For another example, controller 176 may receive an indication of depression of the accelerator pedal, signaling a desire for increased vehicle speed. Vehicle acceleration may be directly proportional to accelerator pedal position, for example, degree of depression. In response, the controller 176 may command operations, such as shifting gear modes of the transmission 108. Alternatively, the gear modes of the transmission 108 may be shifted manually, such as if the transmission 108 is a manual transmission.

The transmission 108 may be a gearbox. Alternatively, the transmission 108 may be an axle transmission or a trans axle transmission, and may be arranged or be part of an axle assembly such as the axle assembly 112. In some embodiments, additionally or alternatively, the transmission 108 may be a first transmission, and the vehicle 100 may have a second transmission. The second transmission may be arranged nearer to the rear side or in another position of the vehicle 100 compared to transmission 108.

The drivetrain 103 is shown in a rear-wheel drive configuration, although other configurations are possible. For one or more examples, the drivetrain 103 may include a front-wheel drive, a four-wheel drive configuration, or an all-wheel drive configuration. Further, the drivetrain 103 may include one or more tandem axle assemblies. For example, there may be one or more axle assemblies in addition to axle assembly 112, and there may be one or more axles in addition to the axle of axle assembly 112. As such, the drivetrain 103 may have other configurations without departing from the scope of this disclosure, and the configuration shown in FIG. 1 is provided for illustration, not limitation. For example, in some embodiments, additionally or alternatively, the transmission 108 may be a first transmission, and the vehicle 100 may have a second transmission arranged on the second set of axle shafts. The transmission 108 may be a gearbox. Alternatively, the transmission 108 may be an axle transmission or a trans axle transmission.

Turning to FIG. 2, a first view 200 of a wheel assembly 202 is shown. The first view 200 is an exploded view of the wheel assembly 202, showing the components of the wheel assembly 202 expanded and decoupled. The components of the wheel assembly 202 are centered on and positioned radially around an axis 210. The axis 210 therein may be a central axis and a longitudinal axis for the wheel assembly 202. The axis 210 may also be a rotational axis that rotating elements of the wheel assembly 202 may rotate or spin about. The wheel assembly 202 may be an example configuration of the first wheel end assembly 142 and/or the second wheel end assembly 144 of FIG. 1.

A set of reference axes 201 are provided for comparison between views shown in FIGS. 2-3. The reference axes 201 indicate a y-axis, an x-axis, and a z-axis. In one example, the z-axis may be parallel with a direction of gravity, and the x-y plane may be parallel with a horizontal plane that a wheel assembly 202 of FIG. 2 may rest upon.

The wheel assembly 202 may have a first side 204 and a second side 206, where the first side 204 is opposite the second side 206. The first side 204 may be a wheel side that may be positioned nearest to a wheel of a vehicle (e.g., a wheel 114). The first side 204 may be positioned nearest to, may abut, and may physically couple to the wheel. The second side 206 may be an axle side that may be positioned closest to the axle of a vehicle, such the axle shaft 118a and/or 118b of the axle assembly 112 of FIG. 1.

The wheel assembly 202 may comprise a plurality of sub-assemblies, including a joint assembly 212 and a hub assembly 214, which are indicated by dashed line boxes. The hub assembly 214 is nearest to the first side 204. The joint assembly 212 is nearest to the second side 206. An axle shaft of an axle assembly (not shown in FIG. 2) may couple to the joint assembly 212, such as to transfer rotational energy to and drive the joint assembly 212. The joint assembly 212 may couple to the hub assembly 214, such as to drive the hub assembly 214. The hub assembly 214 may couple to a wheel, such as to transfer rotational energy to and drive the wheel. A torque generated by the axle shaft may transfer rotational energy to and drive the joint assembly 212 and the hub assembly 214. A stub shaft 218 may couple with the joint assembly 212 and the hub assembly 214. The hub assembly 214 lacks a hub adaptor. As such, the stub shaft 218 may couple to the hub assembly 214 without coupling to a hub adapter. The joint assembly 212 is an example configuration that includes a CVJ used for the first joint 152 and the second joint 154 of FIG. 1.

The joint assembly 212 may include a CVJ 232, a spindle 234, and a bearing assembly 236. The CVJ 232 includes an outer race 238. The bearing assembly 236 includes at least a bearing. The bearing assembly 236 may include a plurality of bearings. The spindle 234 may be disposed between the CVJ 232 and the hub assembly 214. The spindle 234 may house and receive the CVJ 232 and the bearing assembly 236.

The joint assembly 212 may also include a first ring 242 and a second ring 244. The first ring 242 and the second ring 244 may be fasteners, such as snap rings. The first ring 242 and the second ring 244 may retain the bearing assembly 236 to components of the joint assembly 212.

The spindle 234 may include a flange section 246 and a nose section 248. The flange section 246 is a rim that comprises a flange. The flange section 246 may extend radially from the nose section 248. The flange section 246 and the nose section 248 may be centered around the axis 210. The spindle 234 may include a frustoconical section 252 that is frustoconical in shape. The frustoconical section 252 may extend in a radial direction from the nose section 248. The frustoconical section 252 may connect to and extend in longitudinal section from the flange section 246. The frustoconical section 252 comprises a shoulder 254. The shoulder 254 may be a surface that is ring-like in shape. The axis 210 may be normal to the shoulder 254. The flange section 246 may rigidly couple to and abut the hub assembly 214. The nose section 248 may receive the stub shaft 218 via an opening 250. The opening 250 may be a hole that is annular in shape, and may be concentric to the nose section 248.

The hub assembly 214 is a wheel hub that includes a first mounting component 262 that may rigidly couple to a housing 264. The first mounting component 262 may include a flange portion that extends radially outward from an outer circumferential surface 265 of the housing 264, where outward is in a direction away from the axis 210. The hub assembly 214 may include a second mounting component 266 rigidly coupled to the housing 264. The second mounting component 266 may extend radially outward from the outer circumferential surface 265.

The housing 264 may be coupled to the first mounting component 262 and/or the second mounting component 266. The first mounting component 262 may include a plurality of first fits 268 that may receive a plurality of first fasteners 270. The first fits 268 may be through-holes. As such, the first fasteners 270 may extend through the first fits 268 and the first mounting component 262. The first fasteners 270 may be studs. The first fasteners 270 may fasten the first mounting component 262 to the wheel.

The hub assembly 214 and specifically the housing 264 may have a second opening 274. The second opening 274 may be concentric to the first mounting component 262 and the housing 264, where the second opening 274 may be centered on the first axis 210. The second opening 274 may receive a nut 276 and the stub shaft 218. The nut 276 may be a spindle nut that may rigidly couple to the spindle 234.

The stub shaft 218 comprises a shaft section 278 and a flange 280. The shaft section 278 comprises a fastening section 282. The fastening section 282 is an interface that may be received by another component, such that the other component may rigidly couple to the stub shaft 218. The joint assembly 212 may comprise the component, therein the joint assembly 212 may fasten to the stub shaft 218. The fastening section 282 has fastening features that fastens with other fastening features of the component. For example, the fastening section 282 may be an externally splined interface, where the splines are arranged around and face radially outward from the fastening section 282. The splines are fastening features of the fastening section 282, and the splines may be male splines that may mesh with a set of female splines 291 of the joint assembly 212.

The flange 280 may rigidly couple the stub shaft 218 to the hub assembly 214. The flange 280 may include a plurality of second fits 284. The second fits 284 may receive a plurality of second fasteners 286. The second fits 284 may be through-holes. The second fasteners 286 may be bolts. A plurality of third fits 288 may be arranged at an outer surface 289 of a mounting feature 290 of the housing 264 (e.g., facing the first side 204). The mounting feature 290 may be cylindrical in shape and encircle the second opening 274. The mounting feature 290 may also extend longitudinally outward from the housing 264 towards the first side 204. The third fits 288 may be holes. The third fits 288 may receive the second fasteners 286.

The wheel assembly 202 may be divided by a view plane 208, which may extend along axis 210 parallel with the z-axis of the reference axes 201. A cutaway view of wheel assembly 202 along the view plane 208 is shown in FIG. 3.

Turning now to FIG. 3, a cutaway view 300 of the wheel assembly 202 is shown, along the view plane 208 of FIG. 1. The flange 280 may fasten to mounting feature 290 by extending the second fasteners 286 through the second fits 284 and into the third fits 288, such that the second fasteners 286 fasten to the third fits 288. The second fasteners 286 and third fits 288 may have fastening features that may mesh, such as threading that may thread. When meshed, the fastening features may fasten the second fasteners 286 to the third fits 288.

An outer portion 322 of the housing 264 may enclose the nose section 248 and the shaft section 278. The hub assembly 214 includes an opening 324 opposite the outer portion 322 and the hub assembly 214 from the second opening 274. For clarity, the opening 324 may be referred to herein as the third opening 324. The second opening 274 and the third opening 324 may be continuous with the outer portion 322. The nose section 248 may be inserted into the third opening 324.

The bearing assembly 236 may be sandwiched radially between the spindle 234 and the outer race 238. The spindle 234 may encircle the bearing assembly 236, and the bearing assembly 236 may encircle a portion of the outer race 238. The bearing assembly 236 is a support bearing for spindle 234 and the outer race 238, allowing the outer race 238 to rotate freely of the spindle 234. The bearing assembly 236 may have surface sharing contact with the spindle 234 and the outer race 238. The first ring 242 and the second ring 244 may retain the bearing assembly 236 to the spindle 234 and to the outer race 238. The bearing assembly 236, the first ring 242, and the second ring 244 may retain the outer race 238 to the spindle 234. The first ring 242 may extend radially around and in contact with the bearing assembly 236. The bearing assembly 236 may extend radially around and in contact with the second ring 244. The first ring 242 may fasten the bearing assembly 236 to the spindle 234. The second ring 244 may fasten the bearing assembly 236 to the outer race 238. The bearing assembly 236 may have a plurality of bearings 330. The bearings 330 may be ball bearings. The bearing assembly 236 includes a first outer race 326 and a first inner race 328. The first outer race 326 may fasten and rigidly couple to the spindle via fastening by the first ring 242. The first inner race 328 may fasten and rigidly couple to the outer race 238 of the CVJ 232 via fastening by the second ring 244.

There may be additional bearing assemblies from bearing assembly 236. The bearing assembly 236 may herein be referred to as the first bearing assembly 236. A second bearing assembly 332 may be housed by the hub assembly 214. More specifically, the second bearing assembly 332 may be housed by the housing 264 and the outer portion 322. The second bearing assembly 332 may extend around and be in face-sharing contact with an outer circumference of the spindle 234. More specifically, the second bearing assembly 332 may extend circumferentially around and in surface sharing contact with the nose section 248. The second bearing assembly 332 may include a plurality of second bearings 334 and a plurality of third bearings 336. The second bearings 334 and the third bearings 336 may be roller bearings. The second bearing assembly 332 may comprise at least a second outer race 338 and a second inner race 340. The second outer race 338 may rigidly couple to and be in face-sharing contact with the hub assembly 214. The second inner race 340 may rigidly couple to and contact the nose section 248. The second inner race 340 may be in face-sharing contact the nut 276. The nut 276 may extend radially around and in contact with the nose section 248. The nut 276 may fasten to the nose section 248 and retain the second inner race 340 to the nose section 248. The shoulder 254 may support and abut the second bearing assembly 332. For example, the nut 276 may press the second inner race 340 against the shoulder 254. Said in another way, the second inner race 340 may be sandwiched between the nut and the shoulder 254. The nut 276 may prevent sliding of the second bearing assembly 332 to the first side 204 from the nose section 248. The shoulder 254 may prevent sliding of the second bearing assembly 332 to the second side 206 from the nose section 248.

The spindle 234 may include a plurality of volumes including a fourth opening 342 and a passage 344. The fourth opening 342 may be nearest to second side 206 and the CVJ 232. The passage 344 is longitudinally between the fourth opening 342 and the first opening 250. The first opening 250, the passage 344, and the fourth opening 342 may be continuous in volume. Likewise, surfaces that curve radially about and that define the first opening 250, the passage 344, and the fourth opening 342 may be continuous. The fourth opening 342 may have a frustoconical volume. The fourth opening 342 is surrounded and defined by a surface 346. The surface 346 may be frustoconical in shape.

The fourth opening 342 may extend circumferentially around and house the first bearing assembly 236. The fourth opening 342 and the passage 344 may receive and extend around the shaft section 278.

The fastening section 282 may rigidly couple to the outer race 238 via an opening, where the opening receives the fastening section 282. For example, the fastening section 282 may rigidly couple to the outer race 238 via a bore 348. The outer race 238 may include an internally splined interface around the bore 348. The internally splined interface may include the set of female splines 291 facing inward from the bore 348. The bore 348 may receive the fastening section 282. The female splines 291 of the outer race 238 may mesh with the male splines of the fastening section 282, rigidly coupling the outer race 238 and the stub shaft 218.

The CVJ 232 comprises a carrier 352 and an inner race 354, respectively. The carrier 352 may support a plurality of bearings of the CVJ 232. The carrier 352 may be sandwiched between the outer race 238 and the inner race 354. Said in another way, the outer race 238 may surround and contact the carrier 352, and the carrier 352 may surround and contact the inner race 354. The bearings supported by carrier 352 may be ball bearings. The inner race 354 may be centered about a centerline 356. The inner race 354 may rigidly couple to an input to the CVJ 232, such as an axle shaft of an axle assembly. For example, the first shaft 118a or the second shaft 118b of FIG. 1 may rigidly couple to the inner race 354. The inner race 354 may be pivoted with the input. The inner race 354 may be pivoted such that the centerline 356 is non-coaxial with the axis 210.

The inner race 354 may be pivoted at an angle 392 from the axis 210. The angle 392 is an angle at which the centerline 356 may be offset from being coaxial with the axis 210. The angle 392 may less than or equal to first threshold that is a maximum angle. The angle 392 may be greater than the first threshold; however, at an angle greater than the first threshold, torque transferred across the CVJ 232 may be below a second threshold of power, increasing power losses and decreasing the efficiency at which torque is transferred.

In this way, the disclosed system provides for a shaft that may couple a joint assembly of a CVJ to a hub assembly, where the shaft is not integrated as a component of the CVJ. That is, the shaft may be manufactured as a separate component from the CVJ. The shaft may couple with an outer race of the joint assembly, where the shaft is removable and may decouple from the outer race. The shaft may be a stub shaft that may rigidly couple to the CVJ via a fastening section including splines. More specifically, the shaft may rigidly couple to the CVJ via fastening to an outer race via the meshing of splines. In this way, the disclosed system provides for a wheel assembly that can be manufactured in parts that do not exceed size or length thresholds above which manufacturing may be complicated or undesirable. In contrast with other conventional designs, the shaft may have output end that rigidly couples with the hub assembly without splines and without relying on a hub adaptor, but rather via a flange that rigidly couples to a housing of the hub assembly.

The disclosure also provides support for a wheel end assembly of a vehicle, the wheel end assembly comprising: a wheel hub assembly, a stub shaft having a first end including an external splined interface, and a second end including a flange configured to be fastened to the wheel hub assembly, and a constant velocity joint (CVJ), where the CVJ includes an outer race comprising a bore with an internal splined interface configured to mate with the external splined interface of the stub shaft. In a first example of the system, the system further comprises: a spindle interposed between the outer race and the wheel hub assembly. In a second example of the system, optionally including the first example, the system further comprises: a bearing assembly sandwiched between the wheel hub assembly and the spindle. In a third example of the system, optionally including one or both of the first and second examples, the system further comprises: a support bearing interposed between the outer race and the spindle. In a fourth example of the system, optionally including one or more or each of the first through third examples, the system further comprises: two snap rings configured to retain the support bearing and the outer race relative to the spindle. In a fifth example of the system, optionally including one or more or each of the first through fourth examples, the flange is fastened to a housing of the wheel hub assembly via a plurality of fasteners. In a sixth example of the system, optionally including one or more or each of the first through fifth examples, the flange is fastened to a mounting feature that is cylindrical in shape. In a seventh example of the system, optionally including one or more or each of the first through sixth examples, the mounting feature curves around an opening that the stub shaft extends through. In a eighth example of the system, optionally including one or more or each of the first through seventh examples, the mounting feature extends longitudinally outward from the housing towards a wheel of the vehicle, along a central axis of the housing. In a ninth example of the system, optionally including one or more or each of the first through eighth examples, the spindle includes an annular opening along a central axis of the spindle through which the stub shaft protrudes. In a tenth example of the system, optionally including one or more or each of the first through ninth examples, the spindle includes a flange section that extends radially outward from the central axis of the spindle, and a nose section centered around the central axis. In a eleventh example of the system, optionally including one or more or each of the first through tenth examples, the spindle further comprises a frustroconical section between the nose section and the flange. In a twelfth example of the system, optionally including one or more or each of the first through eleventh examples, the nose section is retained to an inner race of the bearing assembly via a spindle nut.

The disclosure also provides support for a constant velocity joint (CVJ) of a vehicle, comprising an outer race including a bore with an internal splined interface configured to mate with an external splined interface of a stub shaft of a wheel end assembly. In a first example of the system, the external splined interface is at a first end of the stub shaft and a second, opposing end of the stub shaft includes a flange configured to be fastened to a wheel hub of the wheel end assembly. In a second example of the system, optionally including the first example, the stub shaft extends from the wheel hub to the CVJ through a spindle, and the stub shaft is supported by a bearing assembly interposed between the outer race and the spindle. In a third example of the system, optionally including one or both of the first and second examples, the CVJ is retained to the spindle via two snap rings. In a fourth example of the system, optionally including one or more or each of the first through third examples, the flange of the stub shaft is fastened to a cylindrical mounting feature of a housing of the wheel hub via a plurality of fasteners. In a fifth example of the system, optionally including one or more or each of the first through fourth examples, the spindle includes a flange section that extends radially outward from a central axis of the spindle, and a nose section centered around the central axis, the nose section retained to an inner race of a second bearing assembly of the housing via a spindle nut.

The disclosure also provides support for a method, comprising: rotating a wheel of a vehicle via a constant velocity joint (CVJ), where a torque generated on an axle shaft of the vehicle is transferred to a stub shaft fastened to a wheel hub including the wheel through the CVJ, the stub shaft having an external splined interface that meshes with an internal splined interface of an outer race of the CVJ.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. For example, the above technology can be applied to powertrains that include different types of propulsion sources including different types of prime movers, internal combustion engines, and/or transmissions. The subject matter of the present disclosure includes all novel and non-obvious combinations and sub-combinations of the various systems and configurations, and other features, functions, and/or properties disclosed herein.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A wheel end assembly of a vehicle, the wheel end assembly comprising:
a wheel hub assembly;
a stub shaft having a first end including an external splined interface, and a second end including a flange configured to be fastened to the wheel hub assembly; and
a constant velocity joint (CVJ), where the CVJ includes an outer race comprising a bore with an internal splined interface configured to mate with the external splined interface of the stub shaft.

2. The wheel end assembly of claim 1, further comprising a spindle interposed between the outer race and the wheel hub assembly.

3. The wheel end assembly of claim 2, further comprising a bearing assembly sandwiched between the wheel hub assembly and the spindle.

4. The wheel end assembly of claim 2, further comprising a support bearing interposed between the outer race and the spindle.

5. The wheel end assembly of claim 4, further comprising two snap rings configured to retain the support bearing and the outer race relative to the spindle.

6. The wheel end assembly of claim 1, wherein the flange is fastened to a housing of the wheel hub assembly via a plurality of fasteners.

7. The wheel end assembly of claim 6, wherein the flange is fastened to a mounting feature that is cylindrical in shape.

8. The wheel end assembly of claim 7, wherein the mounting feature curves around an opening that the stub shaft extends through.

9. The wheel end assembly of claim 7, wherein the mounting feature extends longitudinally outward from the housing towards a wheel of the vehicle, along a central axis of the housing.

10. The wheel end assembly of claim 3, wherein the spindle includes an annular opening along a central axis of the spindle through which the stub shaft protrudes.

11. The wheel end assembly of claim 10, wherein the spindle includes a flange section that extends radially outward from the central axis of the spindle, and a nose section centered around the central axis.

12. The wheel end assembly of claim 11, wherein the spindle further comprises a frustroconical section between the nose section and the flange.

13. The wheel end assembly of claim 11, wherein the nose section is retained to an inner race of the bearing assembly via a spindle nut.

14. A constant velocity joint (CVJ) of a vehicle, comprising an outer race including a bore with an internal splined interface configured to mate with an external splined interface of a stub shaft of a wheel end assembly.

15. The CVJ of claim 14, wherein the external splined interface is at a first end of the stub shaft and a second, opposing end of the stub shaft includes a flange configured to be fastened to a wheel hub of the wheel end assembly.

16. The CVJ of claim 15, wherein the stub shaft extends from the wheel hub to the CVJ through a spindle, and the stub shaft is supported by a bearing assembly interposed between the outer race and the spindle.

17. The CVJ of claim 16, wherein the CVJ is retained to the spindle via two snap rings.

18. The CVJ of claim 16, wherein the flange of the stub shaft is fastened to a cylindrical mounting feature of a housing of the wheel hub via a plurality of fasteners.

19. The CVJ of claim 18, wherein the spindle includes a flange section that extends radially outward from a central axis of the spindle, and a nose section centered around the central axis, the nose section retained to an inner race of a second bearing assembly of the housing via a spindle nut.

20. A method, comprising:
rotating a wheel of a vehicle via a constant velocity joint (CVJ), where a torque generated on an axle shaft of the vehicle is transferred to a stub shaft fastened to a wheel hub including the wheel through the CVJ, the stub shaft having an external splined interface that meshes with an internal splined interface of an outer race of the CVJ.
